(19) United States
(12) Patent Application Publication
(10) Pub. No.: US 2010/0053974 A1
(43) Pub. Date: Mar. 4, 2010

(54) SILICATE CEMENT COMPOSITION AND LAMP ASSEMBLIES COMPRISING SAME

(76) Inventor: Vaughn C. STERLING, Mattoon, IL (US)

Correspondence Address: General Electric Company;GE Global Patent Operation, PO Box 861, 2 Corporate Drive, Suite 648, Shelton, CT, 06484, US

(21) Appl. No.: 12/203,944

(22) Filed: Sep. 4, 2008

(51) Int. Cl. F21V 7/00; C04B 28/26

(52) U.S. Cl. 362/296.05; 106/600; 106/636; 106/605; 106/626; 106/624; 106/635

(57) ABSTRACT

In one aspect of embodiments of the invention is provided a heat-resistant cementitious composition comprising a binder comprising potassium silicate, and at least one filler material, the filler material substantially non-reactive with said potassium silicate; wherein the cementitious composition, in the presence of water, has a ramp flow value of less than about 10 in the substantial absence of vibration; and wherein the cementitious composition, in the presence of water, has both thixotropic flow properties and pseudoplastic flow properties. Also provided are lamp assemblies employing such cementitious compositions.

### FIELD OF THE INVENTION

The present invention relates to a cement composition, and more particularly, to a silicate cement composition having improved flow properties and having resistance to high temperature when cured.

### BACKGROUND

In many high temperature applications, cement compositions having refractory properties are needed. For instance, certain electrical devices such as incandescent, halogen, or high intensity discharge lamps may require assembly from components, and high temperature ceramic compositions are often used to adhere components that may be exposed to elevated temperatures, in order to make effective seals that will not crack or cause other defects in high temperature operation.

In particular, many known electric lamp assemblies are constructed of a light source and a reflector member. The light source (e.g., a halogen lamp capsule) of such assembly is fixed to the assembly in a predetermined way, in order to optically align the light source to the reflector member for optimum reflectance of the light from the light source. Often, the light source is fixed into proper optical alignment with the reflector member by use of a cement composition which may contact the hot envelope of the light source. For this purpose, such cement should be a refractory cement, because the temperature of the envelope of the light source often exceeds 350° C. The cement should also be electrically non-conducting, have the proper thermal conductivity and have a thermal coefficient of expansion which matches that of the reflector member and/or envelope as closely as possible.

One type of refractory cement that has been successfully used commercially for this application has been an aluminum phosphate cement composition, comprising a mixture of aluminum phosphate having an excess of phosphoric acid and filler materials of specified particle size, as described in prior U.S. Pat. Nos. 4,833,676 and 4,918,353 (assigned to the assignee of the present invention). This aluminum phosphate cement composition, referred to as Alpho cement, has seen wide successful use. However, its strength, shelf life, rheology, and cure temperature have not always been entirely satisfactory. Its use can occasionally lead to so-called “loose lamp defects”, where the light source is no longer securely fastened to its lamp assembly.

What is needed in the field is a stable, long shelf life cement having adequate flow properties and ability to resist high temperatures.

### SUMMARY OF THE INVENTION

In one aspect of embodiments of the invention, is provided a heat-resistant cementitious composition comprising a binder comprising potassium silicate, and at least one filler material, the filler material substantially non-reactive with said potassium silicate; wherein the cementitious composition, in the presence of water, has a ramp flow value of less than about 10 in the substantial absence of vibration; and wherein the cementitious composition, in the presence of water, has both thixotropic flow properties and pseudoplastic flow properties.

In another aspect of embodiments of the invention, is provided a lamp assembly comprising a body having a cavity and a reflector member surface; and a light source electrically connected to electric leads, the light source disposed in the body cavity with a heat-resistant cementitious composition at a position so that at least a portion of light emanating from the light source is directed toward the reflector member surface; wherein the cementitious composition comprises: a binder comprising potassium silicate, and at least one filler material, the filler material substantially non-reactive with said potassium silicate; wherein the cementitious composition, in the presence of water, has a ramp flow value of less than about 10 in the substantial absence of vibration; and wherein the cementitious composition, in the presence of water, has both thixotropic flow properties and pseudoplastic flow properties.

Other features and advantages of this invention will be better appreciated from the following detailed description.

### BRIEF DESCRIPTION OF THE DRAWINGS

FIG. 1 shows a schematic diagram of a device for measuring cement flow properties according to embodiments of the invention.

FIG. 2 shows an idealized side cross-sectional view of a lamp assembly having a reflector member and light source, employing cementitious compositions according to embodiments of the invention.

### DETAILED DESCRIPTION

As noted, an embodiment of the invention relates to a heat-resistant cementitious composition comprising a binder comprising potassium silicate, and at least one filler material, the filler material substantially non-reactive with said potassium silicate, wherein the cementitious composition (in the presence of water) has a ramp flow value of less than about 10 in the substantial absence of vibration, and wherein the cementitious composition, in the presence of water, has both thixotropic flow properties and pseudoplastic flow properties. Values for flow properties (such as “ramp flow value” defined hereinunder) and other rheological properties, refer to the values measured for the components of the cement composition when in the presence of sufficient water to form a paste or a slurry. In sum, the term “cementitious composition, in the presence of water” will generally refer to a state where the components of the cement composition are in the presence of sufficient water to form a paste or a slurry. When the phrase “cementitious composition” is used unmodified by “presence of water”, it usually refers to a cementitious composition in any one or more of: a dry, dried, set, cured, or hardened state.

In some embodiments, the cementitious composition, in the presence of water, may exhibit non-Newtonian rheological characteristics, in which its apparent viscosity has a dependence upon one or more of turbulence, shear, or agitation applied to the composition. The rheological characteristics of the cementitious composition, in the presence of water, may be described as being thixotropic, pseudoplastic, or preferably, as having both thixotropic and pseudoplastic characteristics. As is generally known, a reduction in apparent viscosity with applied shear can be time independent (“pseudoplastic”), or can be time dependent (“thixotropic”). As used herein, thixotropy is defined in a general fashion to refer to a property of fluids to show a time-dependent change in apparent viscosity; for example, the longer a thixotropic fluid undergoes shear stress, the lower its apparent viscosity.

A convenient measure of the rheological properties of cementitious compositions according to embodiments of the invention is afforded by following a ramp slide test. In this test, a given mass of cementitious composition as a paste or slurry is applied to an inclined plane, and its flow distance under gravity is measured, in the absence and presence of turbulence or vibration. More specifically, a “ramp slide test”, as the phrase is used according to embodiments of the invention, is conducted by applying 135 g of a test paste or slurry cementitious composition to a flat stainless steel ramp inclined up at 15 degrees; the composition is released through a gate, and then the distance that the leading edge of the test composition flows under gravity in a 5 second period is measured. This flow distance, when measured in mm, is the “ramp flow value”. Typically, this measurement is done firstly in the absence of any applied turbulence or vibration. Secondly, the measurement is performed on an identical sample of test composition in the presence of an effective vibration level. Preferred compositions are those which have a negligible flow (e.g., a ramp flow value of less than about 10 or more preferably less than about 5) in the absence of vibration but which also have adequate flow (e.g., a ramp flow value of greater than about 20, more preferably greater than about 30) in the presence of vibration. As used herein, when ramp flow value testing is done “in the presence of vibration”, this refers to a test vibration having a frequency of about 8500 vpm (vibrations per minute) and an amplitude of about 1100 N (newtons). On the other hand, compositions which have a significant flow when in the absence of vibration are not preferred for use in embodiments of the invention.

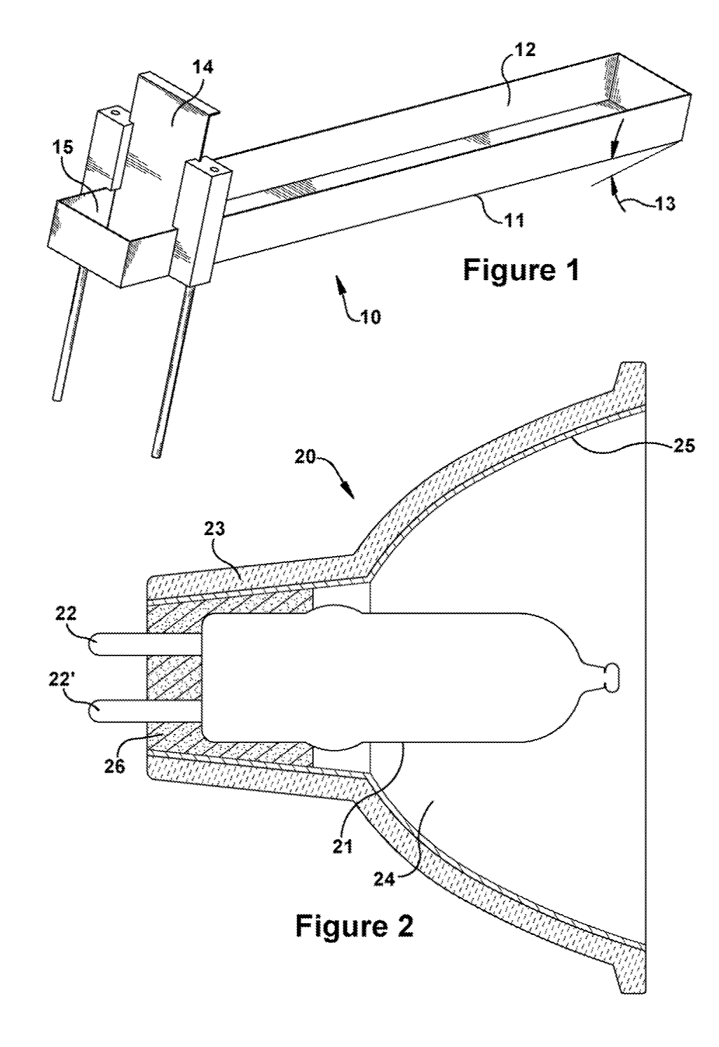

A schematic diagram of a suitable incline plane device for measuring flow properties is shown in FIG. 1. The device 10 comprises a rectangular stainless steel box 11 having an open top 12. It had dimensions of approximately 40 mm width, 20 mm depth, and 320 mm long, and was inclined at an angle 13 of 15°. At an upper portion thereof a thin steel retractable sluice gate 14 was provided, defining a reservoir zone 15 for the pasty cement mass. An appropriate quantity (i.e., 135 g) of the test mass would be placed in the reservoir zone 15, and then the gate 14 would be carefully retracted upwards to allow the mass to flow, and the flow distance under gravity would be measured over the next five seconds. This flow distance would be measured in the substantial absence of any vibration or shear forces, and then would be measured again for a mass of the same quantity and composition, this time under conditions of effective turbulence or vibration to cause flow, i.e., a test vibration having a frequency of about 8500 vpm (vibrations per minute) and an amplitude of about 1100 N (newtons).

The cementitious composition in accordance with embodiments of the present invention comprises a potassium silicate and one or more filler material, wherein the filler materials are substantially non-reactive with potassium silicate and are selected from materials effective to give the required flow properties when the composition is in the presence of water. In formulating a cementitious composition according to embodiments, the potassium silicate binder component may be provided in solid or liquid form; for example, it may be provided as a powder (e.g., spray-dried), or as a slurry, or as a solution in water. When provided as a solution, the mass percent of solids in the solution may be at any concentration, for example, from about 30 to about 50 weight percent. Commercial forms of potassium silicate solution often have mass percent of from about 35-40 wt %. In some embodiments, potassium silicate solutions are employed to formulate cementitious compositions, where the solution has a Si/K atomic ratio of from about 0.5 to about 2.0. In other embodiments, substantially stoichiometric forms of potassium silicate can be employed to formulate a cementitious composition, where the Si/K atomic ratio is about 0.5. Potassium silicate has been found by applicant to be more suitable for lamp applications than other alkali metal silicates, owing to its reduced reactivity with glass envelopes.

According to embodiments, a cementitious composition may contain potassium silicate in an amount of from about 1 to about 10 wt % (and more narrowly, from about 3 to about 8%), on a dry basis, based on total dry composition. As is generally understood, the term “based on total dry composition” refers typically to the weight of the solids in the cementitious composition, neglecting any mass contribution from water. For example, 16 g of spray-dried potassium silicate powder on the one hand, and 40 g of a 40% w/w solution of potassium silicate on the other hand, are both considered to contain 16 g of potassium silicate “on a dry basis”.

In accordance with further embodiments of the invention, the filler material of the cementitious composition comprises at least some coarse filler particles, defined as those having a mean particle size of from about 20 to about 110 microns. In addition, these coarse filler particles may have a particle size distribution such that about 95 to 100 wt % of the coarse filler particles have a particle size less than 110 microns, based upon the total weight of the coarse filler particles. In yet further embodiments, such coarse filler particles may have a mean particle size of from about 20 to about 50 microns, and a particle size distribution such that about 50 to 100 wt % of the coarse filler particles have a particle size less than 50 microns, while about 95-100 wt % have particle size less than 110 microns, based upon the total weight of the coarse filler particles.

Some suitable materials for use as coarse filler particles include microspheres, examples of which are known to the skilled practitioner. Examples may include cenospheres, hollow microspheres, and FILLITE (trademark of Trelleborg Fillite Inc. Suwanee Ga. for ceramic spheres); or the like. In other embodiments, the coarse filler particles may be characterized by chemical composition, i.e., as comprising an aluminosilicate (for example, one or more selected from the group consisting of aluminosilicate cenospheres, fly ash, aluminosilicate zeolites; or the like). Often, aluminosilicate microspheres are employed. Of course, other materials can be employed as coarse filler particles, in addition to or in place of the materials named here.

Cementitious compositions of embodiments of the invention may comprise coarse filler particles in an amount of from about 15 to about 40 wt % (and more narrowly, from about 20 to about 30 wt %) on a dry basis, based on the total dry weight of cementitious composition.

In some embodiments of the invention, the filler material may comprise medium filler particles in place of (or preferably in addition to) the coarse filler particles noted above. As used herein, medium filler particles are broadly defined as having a mean particle size of from about 0.1 to about 17 microns; in a more narrow definition, medium filler particles are defined as having a mean particle size of from about 0.5 to about 15 microns. Such medium filler particles may comprise a wide variety of refractory materials, such as, for example, one or more titanate or a zirconate of an alkaline earth metal. In one embodiment, medium filler particles comprise barium titanate. Of course, other materials can be employed as medium filler particles, in addition to or in place of the materials named here.

Cementitious compositions of embodiments of the invention may comprise medium filler particles in an amount of from about 30 to about 60 wt % (and more narrowly, from about 45 to about 60 wt %) on a dry basis, based on the total dry weight of cementitious composition.

Cementitious compositions according to embodiments may also comprise filler materials comprising an alumina, for example, any form of alumina such as corundum or fired aluminas or hydrated or partially hydrated aluminas. When present, such aluminas typically (but not always) have a mean particle size less than that of the medium filler particles. The cementitious composition may comprise an alumina in an amount of from about 6 to about 20 wt % (and more narrowly, from about 10 to about 15 wt %) on a dry basis, based on the total dry weight of cementitious composition.

Materials used as filler materials should also be refractory in the sense that they are not affected by the relatively high temperatures of 350° C. to 600° C. which may be encountered in some high temperature electrical (e.g., lamp) applications. The filler materials should also be relatively electrically non-conducting.

A wide variety of methods commonly employed by practitioners skilled in the art may be used to prepare the present cementitious compositions. For instance, a composition can be prepared by mixing an aqueous solution of potassium silicate with at least one filler material in the presence of sufficient water to form a paste or slurry. If such an aqueous solution of potassium silicate already contains a sufficient amount of water, none need be added, but optionally water may be added if required. Alternatively, any convenient dry form of potassium silicate may be combined with dry or slurry forms of filler materials, in any combination and in any order. The particular mixing sequence is not believed to be critical to forming the paste or slurry which is ultimately heated to form a cement. In each case, water may be optionally be added if required to form a paste or a slurry. In certain embodiments, the total water which may be present in a paste or a slurry may comprise an amount of from about 10 to about 30 wt % (and more narrowly, from about 15 to about 25 wt %), based on a combined mass of binder (calculated as dry), filler materials, and water.

It will be understood that the rheology of the final slurry or paste can be somewhat affected by the amount of water present, the amount of the binder present with respect to the filler materials, the relative particle size of the binder and/or filler materials, etc. Thus, the actual amounts of the various ingredients with respect to each other employed in forming the cementitious composition (according to embodiments of the invention), may vary. However, it is believed that any person of ordinary skill in this art can, without any undue experimentation, discover the parameters of water content, particle size, and quantities needed to achieve the requisite flow properties, taking into account the description and examples given herein and common knowledge in the field.

When in the presence of water, cementitious compositions according to embodiments have a room temperature drying time of greater than about 1 min, or more preferably, greater than about 10 minutes. Such extended drying time periods at room temperature can help avoid undesired drying from occurring within dispensing equipment. Drying times that are unacceptably short (e.g., less than about 15 seconds) are less preferred.

In order for the cementitious composition to achieve its full strength, a curing step is usually needed. This can take place at a temperature less than about 350° C. (e.g., from 200-340° C.) or more narrowly, at a cure temperature less than or equal to about 250° C. (e.g., 200-250° C.). The corresponding cure time at 250° C. can be typically greater than about 20-60 sec, or more narrowly, about 30-50 sec. Short cure times can enable rapid assembly of components. Cure strengths of greater than 25 psi and more preferably, greater than 75 psi (e.g., 75-200 psi) can be achieved.

As noted previously, embodiments of the invention are also directed to a lamp assembly comprising a body having a cavity and a reflector member surface; and a light source electrically connected to electric leads, where the light source is disposed in the body cavity using a heat-resistant cementitious composition at a position so that at least a portion of light emanating from the light source is directed toward the reflector member surface. FIG. 2 shows an exemplary lamp assembly 20 having a light source 21 connected to electric leads 22, 22′, and a body 23 having a cavity 24 and a reflector member surface 25. A light source 21 (e.g., halogen lamp capsule) is at least partially surrounded by the body 23, suitable to the type and shape of the light source used. Although the body 23 is shown as concave, it may take other shapes and forms known to those skilled in the art. The body 23 is typically secured to the light source 21 disposed in the body cavity 24 by the subject cementitious composition 26. When energized, the light source 21 produces both visible light and infrared radiation. The reflector member surface 25 typically includes a substrate (not specifically shown) of glass or a polymeric material that is coated with a dichroic coating. Such surface typically reflects at least the visible light.

The types of lamp assemblies contemplated herein can include the well known MR16 family of lamp, which employs a halogen-tungsten filament lamp capsule in combination with a reflector member; but it can also be any kind of lamp which employs a reflecting surface. Light sources for such lamps can include incandescent, fluorescent, light emitting diode (LED), electroluminescent devices (e.g., OLED), halogen, high intensity discharge lamps, or any combination thereof.

As is well known in the art, lamps having a light source and reflector member surface often require assembly, either manually or in automated fashion. For instance, automated methods for manufacturing reflector lamps are shown in U.S. Pat. No. 5,230,647, hereby incorporated by reference. As noted above, in the field of lamp assembly, a step of aligning a light source (e.g., a halogen lamp capsule) is needed so that light is optimally reflected by the reflector member surface of the lamp. Machines for automated manufacture and/or alignment of reflector lamps usually have a characteristic vibration feature, and cementitious compositions according to embodiments of this invention have flow properties that are advantageously well-suited to match the vibration features of automated manufacturing equipment.

In order to promote a further understanding of the invention, the following examples are provided. These examples are shown by way of illustration and not limitation.

### EXAMPLES

### Example 1

One effective formula for a cementitious composition is as follows: 1016 grams barium titanate (having a mean particle size of from 0.6-15 microns) was combined with 250 grams fine fired alumina, 490 grams FILLITE-106 (aluminosilicate cenospheres available from Trelleborg Fillite, Inc., Suwanee Ga.), 300 grams of a 40 wt % potassium silicate solution, and 290 grams de-ionized water. The pasty mass had properties of both thixotropy and pseudoplastic flow. It could be dried with hot flowing air and cured at 250° C.

This material was characterized by a long shelf life (greater than 14 days), and adequate flow properties to match reflector lamp assembly manufacturing equipment. In particular, it exhibited a ramp flow value of zero with no vibration, and also a ramp flow value of 40 in the presence of vibration. In use, it exhibited high strength (greater than 100 psi), proper thermal conductivity, and a thermal expansion coefficient which matched that of low expansion #33 glass.

### Example 2

A comparative Alpho cement was prepared according to the example shown in U.S. Pat. No. 4,833,576. It exhibited a short shelf life of around 2 days, a high cure temperature of 350° C., and a prolonged drying time. Most pertinently, when formed into a paste it exhibited an unacceptably high ramp flow value of 35 even with no vibration.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” used in connection with a quantity is inclusive of the stated value and has the meaning dictated by the context (for example, includes the degree of error associated with the measurement of the particular quantity). “Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present. The singular forms “a”, “an” and “the” include plural referents unless the context clearly dictates otherwise. All ranges disclosed herein are inclusive of the recited endpoint and independently combinable.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A heat-resistant cementitious composition comprising:
a binder comprising potassium silicate,
at least one filler material, said filler material substantially non-reactive with said potassium silicate;
wherein said composition, in the presence of water, has a ramp flow value of less than about 10 in the substantial absence of vibration; and
wherein said composition, in the presence of water, has both thixotropic flow properties and pseudoplastic flow properties.

2. The composition of claim 1, wherein said composition, in the presence of water, has a cure temperature of less than about 350° C.

3. The composition of claim 1, wherein said composition, in the presence of water, has a room temperature drying time of greater than about 1 min.

4. The composition of claim 1, wherein said composition, in the presence of water, has a cure time of greater than about 30 sec at 250° C.

5. The composition of claim 1, wherein said composition, in the presence of water, has a ramp flow value of greater than about 20 when subjected to vibration having a frequency of about 8500 vpm and an amplitude of about 1100 N.

6. The composition of claim 1, further comprising water present in an amount of from 10-30 wt %, based on a combined mass of binder, filler, and water.

7. The composition of claim 1 wherein said composition has a strength, after admixture with water and curing, of greater than about 25 psi.

8. The composition of claim 1 wherein the filler material comprises coarse filler particles having a mean particle size from about 20 to about 110 microns.

9. The composition of claim 8, wherein about 95 to 100 wt % of the coarse filler particles have a particle size less than 110 microns, based upon the total weight of the coarse filler particles.

10. The composition of claim 8, wherein the coarse filler particles comprise microspheres.

11. The composition of claim 8, wherein the coarse filler particles comprise an aluminosilicate selected from the group consisting of cenospheres, fly ash, aluminosilicate zeolites, and combinations of the foregoing.

12. The composition of claim 1, wherein the filler material comprises medium filler particles having a mean particle size of from about 0.1 to about 17 microns.

13. The composition of claim 12, wherein the medium filler particles comprise a titanate or a zirconate of an alkaline earth metal.

14. A heat-resistant cementitious composition comprising:
a binder comprising potassium silicate,
at least one filler material, said filler material substantially non-reactive with said potassium silicate;
wherein said composition, in the presence of water, has a ramp flow value of less than about 10 in the substantial absence of vibration; and
wherein said composition, in the presence of water, has both thixotropic flow properties and pseudoplastic flow properties;
wherein said composition comprises, on a dry basis:
a binder comprising potassium silicate in an amount of from about 1 to about 10 wt %, and
a filler material comprising about 30 to about 60 wt % barium titanate, about 6 to about 20 wt % of alumina, and about 15 to about 40 wt % of an aluminosilicate;
each wt % is based on the total dry composition.

15. A lamp assembly comprising:
a body having a cavity and a reflector member surface;
a light source electrically connected to electric leads, said light source disposed in the body cavity with a heat-resistant cementitious composition at a position so that at least a portion of light emanating from the light source is directed toward the reflector member surface;
wherein said heat-resistant cementitious composition comprises a binder comprising potassium silicate and at least one filler material, said filler material substantially non-reactive with said potassium silicate;
wherein said composition, in the presence of water, has a ramp flow value of less than about 10 in the substantial absence of vibration; and
wherein said composition, in the presence of water, has both thixotropic flow properties and pseudoplastic flow properties.

16. The lamp assembly of claim 15, wherein the filler material comprises coarse filler particles of mean particle size from about 20 to about 50 microns, wherein about 95 to 100 wt % of the coarse filler particles have a particle size less than 110 microns, and about 50 to 100 wt % of the coarse filler particles have a particle size less than 50 microns, based upon the total weight of the coarse filler particles.

17. The lamp assembly of claim 16, wherein the coarse filler particles comprise microspheres.

18. The lamp assembly of claim 15, wherein the filler material comprises medium filler particles having a mean particle size of from about 0.1 to about 17 microns.

19. The lamp assembly of claim 18, wherein the medium filler particles comprise a titanate or a zirconate of an alkaline earth metal.

20. The lamp assembly of claim 15, wherein the filler material comprises an alumina.
